(19) United States
(12) Patent Application Publication
(10) Pub. No.: US 2020/0231281 A1
(43) Pub. Date: Jul. 23, 2020

(54) DISPERSION AIRCRAFT

(71) Applicant: DRONE AIR FLY, La Louptière Thénard (FR)

(72) Inventors: Jean-Baptiste Bruggeman, La Louptière Thénard (FR); Christophe Pierre, Le Noirmont (CH); Mostafa Kasbari, Pourrières (FR)

(73) Assignee: DRONE AIR FLY, La Louptière Thénard (FR)

(21) Appl. No.: 16/647,731

(22) PCT Filed: Sep. 26, 2018
(86) PCT No.: PCT/FR2018/052375

§ 371 Date: Mar. 16, 2020

(30) Foreign Application Priority Data
Sep. 27, 2017 (FR) 17 58932

(51) Int. Cl. B64D 1/18; B64C 39/02; B64D 41/00; A01M 25/00; A01M 7/00

(52) U.S. Cl. CPC B64D 1/18; B64C 39/024; B64D 41/00; B64C 2201/12; A01M 7/0042; B64C 2201/021; B64C 2201/104; A01M 25/006

(57) ABSTRACT

Drone for dispersing capsules containing biological active agents for combatting pests, including propulsion means ensuring movement of the aircraft in a horizontal direction parallel with the ground and a capsule distributing and jettisoning system with a vertical ejector, for in-flight ejection of the capsules toward the ground in a direction perpendicular to the horizontal direction of movement of the drone. Taking into account the movement direction of the drone, the vertical ejector is positioned in front of the propulsion means, and the capsule distribution and jettisoning system includes a capsule reservoir which is connected to an element for guiding the capsules toward a capsule counting and metering system including a plate for selecting and separating the capsules, the plate having holes calibrated for the passage of a single capsule toward the vertical jettisoning ejector and being mounted for rotation relative to the vertical ejector via a thrust generating motor.

### BACKGROUND OF THE INVENTION

### (1) Field of the Invention

The present invention falls within the field of spraying in crop fields.

The invention particularly relates to an aircraft for spraying, in particular a drone for spraying capsules containing biological agents for pest control.

Such a device will find a particular application in the agricultural field, in particular in the field of biological control of harmful living organisms referred to as “pests” causing damage to crops and agricultural fields.

More specifically, so far, in order to biologically control pests, it is usual to spray on the fields capsules comprising living biological agents preventing the destructive activity of pests.

For example, in order to control the corn borer, it is common to spray on the fields capsules containing Trichogramma larvae preventing the birth of the borer, hence their devastating activity on the crop fields.

For example, it is also possible to spray in capsules:
bacteria, in particular of the Bacillus type, to control caterpillar;
viruses, such as the granulose virus, to control the codling moth;
eggs or larvae of insects, pheromones,
fungi such as queanthomphtorals against aphids.

It should be noted that spraying using capsules containing biological agents requires a distribution of the latter over all of the cultivated parcels to be treated, most often according to at least a 20 m×20 m grid, in a regular and specific manner.

### (2) Description of the Prior Art

Traditionally, spraying occurs manually. Now, this requires too long a time of carrying out, tedious work and a high labor cost, resulting into an economic loss.

In order to limit labor costs and reduce the time required for carrying out the spraying, automatic aerial spraying devices such as helicopters, ULMs or drones have been tried. Generally, these devices are equipped with a system for dispensing and releasing capsules containing the biological agents.

Nevertheless, these devices are not fully satisfactory on many aspects, therefore the Brazilian and French public research centers have requested a call for tenders for developing a solution that addresses these issues.

Indeed, depending on the flight plans, the speed of movement of the current devices, the generated turbulences, the spraying is inaccurate and does not permit to homogeneously distribute the capsules containing the biological agents over the desired area. For example, the current solutions do not permit to obtain a spacing between each capsule of 20 m or 15 m both along the width and along the length with an accuracy of a few tens of centimeters. The distribution and the release are random and do not permit a treatment adjusted to the field areas likely to be ravaged by pests with an accuracy required to obtain a real effectiveness of the treatment.

The helicopters and ULMs (Ultra-Light Engine-driven Aircrafts) require the intervention of a pilot on board, who must be paid, which disadvantageously increases the costs associated with the field spraying operation. The risks of serious accidents for the passenger and the equipment are significant and increased by the need to fly at very low altitude. The complexity of implementation and the associated costs have not permitted the biological control to completely replace the treatments with chemical insecticides, since the 1990s. The current solutions have not been satisfactory.

In addition, both for helicopters and for ULMs, since the flight height, relative to the surface of the field, is higher than for using a drone, the accuracy of the release of the capsules is complex, because of the distance from the ground. Indeed, it is more difficult to have a release accuracy when flying at a high altitude than when flying at low altitude.

In addition, the helicopters or ULMs are heavy and bulky vehicles, their means of propulsion is generally of the multi-propeller type or with very bulky blades. Now, the more the number of propellers and/or blades increases, the higher are the turbulences in flight and the more the accurate release becomes difficult, because the movement in flight is unstable.

In order to partially cope with these problems, it is known to use drones.

The drones have the advantage of not requiring a pilot on board, therefore, the costs associated with the operator are low, the use of a drone does not endanger a pilot or people on the ground.

The drones are also light and weigh only a few kilos in total compared to helicopters or ULMs, they can fly at very low altitude, close to the ground, which permits to achieve a high accuracy in the distribution of the capsules on the ground. Indeed, the more the flight is carried out at low altitude and close to the crops, the higher is the accuracy of release of the capsules, in order to achieve positioning in the parcels with much higher accuracy than with heavier aircraft such as helicopters or ULMs.

Nowadays, the drones used are of the multi-copter type with at least six propellers generating turbulences and their flight energy autonomy is often less than 30 min, the quantities of capsules that they can embark are low, their speed of movement is very limited. This is why, in general, the current drones permit to treat only 5 or 6 ha per flight, with the need to recharge the batteries and replenish the capsule reservoir. This is therefore very disadvantageous, it is necessary to find an alternative solution to the existing drone that permits, without requiring a frequent recharging, to treat a large cultivated parcel.

Thus, the flight autonomy and the speed of movement of these drones known from the prior art do not permit to carry out the spraying operation quickly and over a large field area.

This does not permit a quick intervention on a set of parcels having large areas within a limited time, which generates a loss of time in the treatment process of the parcel.

In addition, the prior-art devices, in particular the drones, are generally of the multi-copter type, with one or more rotary-wing propellers. Now, the presence of this multiplicity of propellers and their positioning on the device generates instability during the flight and creates areas of turbulence, namely around the capsule-releasing device. These turbulence areas are generated by the rotation of the propellers. The latter are often close to the capsule-releasing device, they have an impact on the accuracy of releasing of the capsules in flight by interfering with the release trajectory. Thus, there is a decrease and loss of accuracy in releasing the capsules, hence a risk of not correctly distributing over a field area, which should nevertheless be treated by the passage of the aerial device.

During the flight and during the release operation, if the device is unstable and the biological agent dispensing system experiences turbulence, the release of the capsules containing the biological control agents and the distribution on the fields will be unpredictable.

Despite a capsule dispensing system permitting an accurate dosing, or even a controlled flight plan, the existing risk of turbulences prevents an accurate spraying, resulting into a loss of pest treatment capacity and quality.

There is then a risk that all the parcels will not be treated against pests, because the distribution of biological agents during the spraying was faulty on some parcels of land.

Thus, an alternative solution should be found to the aerial spraying device known from the prior art, which:
permits an accurate and controlled distribution of biological agents,
is accurate on the flight paths and the release of the capsules,
permits to cover in a minimum number of flights, ideally a single flight, the entire area to be treated,
is carried out as quickly as possible, within a short time, on the largest possible surface,
is as effective as possible and provides only the dose, but all the necessary dose, of biological agents on each plot of land,
specifically targets the parcels of land to be treated by releasing the dose of capsules containing the biological agents only on the field areas to be treated against pests and with an accurate distance between each capsule; distance that must be predefined and adjustable depending on the density of parasites to be treated in each parcel.

### SUMMARY OF THE INVENTION

The aim of the present invention is to cope with the drawbacks of the state of the art, by providing an aircraft for spraying, more precisely a drone for spraying capsules containing biological agents for pest control.

Said drone for spraying comprises:
a propulsion means ensuring the displacement of the drone in a horizontal direction parallel to the ground
a system for dispensing and releasing said capsules provided with a vertical ejector, so that the ejection in flight to the ground of said capsules occurs in a direction perpendicular to said horizontal direction of displacement of the drone.

According to a preferred embodiment of the invention, said propulsion means consists of a single rotating propeller.

Advantageously, said propeller is rotating in a vertical plane in order to minimize as much as possible the turbulences generated on the drone in flight.

Specifically to the drone of the invention, taking into consideration the direction of displacement of the drone, said vertical ejector is positioned in front of said propulsion means.

Thus, since said vertical ejector is positioned in front of the propulsion means, the risk of turbulence during the ejection of the capsules containing the biological agents is at its minimum.

Indeed, the turbulences generated by said propulsion means and in a nearby area are not inconsistent with causing the path of the capsules to deviate during the ejection to the ground.

More specifically, the distance separating the propulsion means and the vertical ejector on the drone is advantageously as large as possible in order to further limit the risk of turbulences.

In this way and thanks to the specific positioning of the ejector in front relative to the rear propulsion means, the risk of deviation of the capsules at the start of ejection, by the turbulences of the propulsion means, is negligible. Thus, the capsule release on the field to be treated is increased in accuracy.

In addition, according to further features, the spraying drone:
consists of a fixed flying wing,
comprises means for managing, through software, the flight plan, the speed of displacement of the drone, the frequency of release of the capsules by the dispensing and release system relative to the surface to be treated, the number of capsules available and the area to be treated.

Advantageously, said drone of the invention carries out parallel flight lines in order to obtain an exact distance in the width direction, and an exact distance in the direction of displacement being triggered depending on its GPS position or according to a space-time at constant speed. This displacement system is programmed from a ground base in radio contact with the drone.

Thus, the flight conditions for the displacement of the drone as well as the frequency and the areas for releasing the capsules containing the biological agents are controlled by one or more software programs. The associated software permits a single operator to control up to four drones that operate simultaneously.

According to another feature of the invention, said system for dispensing and releasing said capsules comprises a capsule reservoir connected to an element for guiding said capsules towards a capsule counting and dosing system, said counting and dosing system comprises a capsule selection and isolation plate, said plate being provided with calibrated orifices for the passing through of a single capsule towards said vertical release ejector, said plate being mounted in rotation relative to said ejector through a pulse generating motor.

Said system for dispensing and releasing said capsules of the drone of the invention permits a unitary exit and release of capsules through said vertical ejector, which is of about four capsules per second, hence a high speed for spraying in fields. In comparison, the drones of the known prior art permit the unitary release of only one capsule every five or 10 seconds or per group with inaccurate random dispersion.

Indeed, in the invention, the transfer and selection of capsules is very quick, it is conditioned by the speed of rotation of the plate and its ability to select one capsule per orifice.

According to the invention, with said capsule dispensing and release system, on average ¼ of a second elapses between the ejection of one capsule and the ejection of the next capsule.

According to a particular embodiment, said counting and dosing system comprises an infrared capsule detection system, so as to be capable of counting the number of capsules dispensed and released, to ensure that no failure of exiting of the capsule occurred and that the system does not show any malfunction such as jamming or slowing down . . . .

Thus, according to the invention, said capsule reservoir permits to store the capsules within the spraying drone before they are released to the ground.

Advantageously, the guiding element will permit a distribution and dispensing of the defined capsules, with certainty one by one. The guiding element will permit a dispersion and a first disintegration of the capsules at the outlet of the tank. Thus, the capsules will be able to reach the counting and dosing system in a non-agglomerated way.

The dosing of the capsules and their selection before they are released by the ejector are carried out by at least one plate mounted movable in rotation relative to the orifice of the ejector and having calibrated orifices for the passing through of a single capsule.

In this way, a second disintegration of the capsules is carried out before they are passing through the duct of the ejector, thus the ejector will be capable of letting through only one single capsule at a time.

An infrared capsule detection system positioned at the outlet of the orifice of the plate or at the outlet of the ejector permits to detect the passing throughᵢ and the presence of a capsule, i.e. its exiting for release to the ground.

Preferably, this system is connected to means for collecting drone flight data in order to be able to subsequently define statistics of correspondence between the number of capsules actually released and the number programmed by the flight plan management means.

As a result, during the flight, according to the movement of the plate, the orifices will end up facing the ejector duct. As a result, the capsules will be able to leave the drone in order to drop to reach the soil to be treated.

According to a first embodiment of the invention, the rotary motion of the plate is provided by a pulse generating motor comprising a valve connected to a motor with permanent rotation through a connecting-rod system.

According to a second embodiment of the invention, the rotary motion of the plate is provided by a pulse generating motor comprising a stepping motor.

Further features and advantages of the invention will become evident from the following detailed description of non-restrictive embodiments of the invention, with reference to the attached figures.

### BRIEF DESCRIPTION OF THE DRAWING

In the attached figures:

FIG. 1 schematically shows a top view of a particular embodiment of the drone of the invention;

FIG. 2 schematically shows a side view of the capsule dispensing and release system;

FIG. 3 schematically shows a cross-sectional profile view of the capsule dispensing and release system;

FIG. 4 schematically shows a view from below of the capsule dispensing and release system.

### DETAILED DESCRIPTION OF THE PREFERRED EMBODIMENTS

The present invention relates to an aircraft 1 for spraying capsules 11 such as a drone 1.

The latter contain biological agents for pest control to be sprayed on the plants of the field to be treated.

Advantageously, the aircraft 1 consists of a fixed flying wing, in particular such as a drone 1. The flying wing has the advantage of being stable in space and during the flight. The drone 1 comprises at least one propulsion means 2.

According to a preferred embodiment, said propulsion means 2 consists of a rotary propeller with a horizontal axis of rotation parallel to the ground.

Said propulsion means 2 ensures the displacement of the drone 1 in a horizontal direction parallel to the ground, which permits the drone 1 to fly over the area to be treated. The drone 1 of the invention also includes a system for dispensing and releasing 3 the capsules 11 towards the field to be treated during the flight of the drone 1.

Advantageously, said dispensing and release system 3 is provided with a vertical ejector 31 through which the capsules 11 to be ejected pass during the flight.

The vertical ejector 31, advantageously consisting of a tube, permits to proceed so that the capsules 11 are ejected towards the soil to be treated during the flight.

The ejector 31 is vertical, oriented downwards, so that the exiting of the capsules 11 occurs in a direction perpendicular to the direction of displacement of the drone 1 in a horizontal direction and in a plane parallel to the ground.

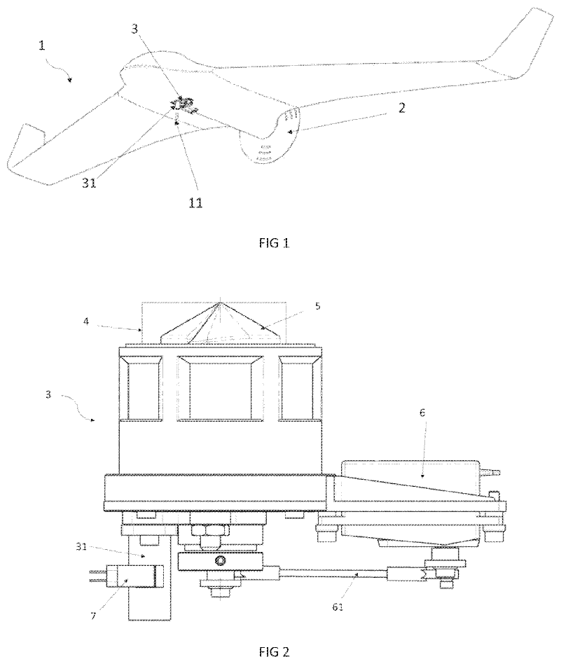

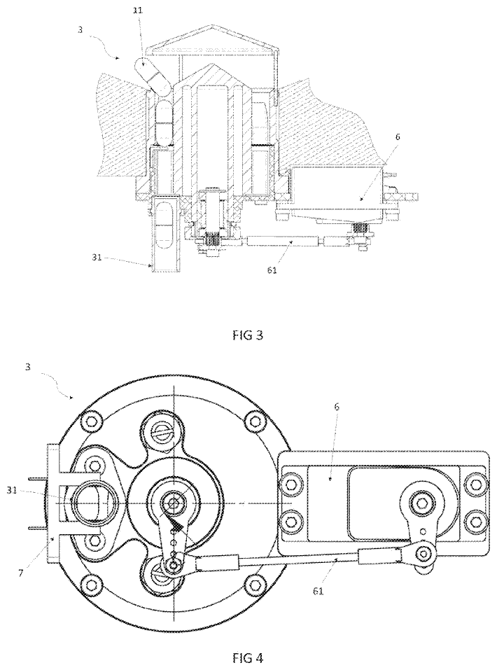

Specifically according to the invention, taking into consideration the direction of displacement of the drone 1 during the flight, said vertical ejector 31 is positioned before said propulsion means 2, i.e. the propeller, as can be seen in FIG. 1.

In other words, said propulsion means 2, permitting to cause the drone 1 to move forward in a horizontal direction during the flight, is located at the rear of the drone 1 and opposite the vertical ejector 31, which is in turn located at the front.

Thus, the fact that the ejector is positioned before the propulsion means 2 permits to avoid the impact of the turbulences, generated by the operation of the propulsion means 2, on the direction of exit of the capsules 11 towards the soil to be treated.

In this way, thanks to the position of the vertical ejector 31 relative to the position of the propulsion means 2, the trajectory of the capsules 11 leaving the ejector is not altered by the turbulences of the propulsion means 2 during operation.

As a result, the ejection of the capsules 11 is more controllable so that they can reach the desired targets on the field to be treated.

Advantageously, in order to control the ejection of the capsules 11 onto their targets, said drone 1 comprises management means, through software:
for the flight plan,
for the speed of movement of the drone 1,
for programming flight lines perfectly parallel to each other,
for the frequency of release of the capsules 11 by the dispensing and release system 3 relative to the surface to be treated,
for the quantity of release of the capsules 11 onto the soil, i.e. for the number of capsules 11 available, and
for the area to be treated, in order to be able to recognize and select it.

Thus, through the software, it is possible to adjust the release of the capsules 11 depending on the areas to be treated, over which the drone 1 is flying.

According to a specific embodiment of the invention, said system for dispensing and releasing 3 said capsules 11 comprises a reservoir 4 with capsules 11.

Advantageously, the reservoir 4 permits to carry a quantity of capsules 11 for treating an area of up to 100 ha in a single one-hour flight.

According to the invention, said reservoir 4 is connected to an element 5 for guiding said capsules 11 to a capsule counting and dosing system 11.

Preferably, said element 5 for guiding the capsules 11 consists of a conical element permitting a distribution of the capsules 11 ending onto the counting and dosing system.

Advantageously, said counting and dosing system comprises a plate for selecting and isolating the capsule 11. Said plate being provided with calibrated orifices for the passing through of a single capsule 11 towards said vertical ejector 31 for release.

Each orifice only permits the passing through one by one of a capsule 11. As a result, the ejection of the capsules 11 onto the ground occurs one by one.

In other words, and in order to avoid a clogging of the orifices of the plate, the conical element will perform the connection between the reservoir 4 of capsules 11 and the plate so that a single layer of capsules 11 can be oriented towards the holes of the plate. The congestion of the orifices of the plate is therefore not possible, thanks to the presence of the conical element, which homogenously distributes the capsules 11.

In addition, said plate is mounted in rotation relative to said ejector 31 through a pulse generating motor 6.

According to a first embodiment visible in the figures, said pulse generating motor 6 comprises a valve connected to a permanently rotating motor through a connecting rod system 61.

According to another embodiment, said pulse generating motor 6 comprises a stepping motor.

Thus, through the operation of the pulse generating motor, said selection and dosing plate will be submitted to rotations following the different pulses. Each pulse will cause an orifice to be positioned in front of the opening of the ejector 31, which will permit the passing through of a capsule 11 and its exit towards the ground.

Advantageously, said counting and dosing system 6 comprises an infrared system for detecting 7 the capsules 11, so as to be capable of counting the number of capsules 11 dispensed and released during the flight. Thus, under the action of a pulse, the plate rotates, and one of its orifices will coincide with the opening of the tube of the ejector 31 to then permit one capsule 11 to pass.

The drone of the invention equipped with its dispensing and release system has an energy autonomy, a capsule embarking capacity and a flight speed permitting to treat up to 100 ha per flight and in one hour; i.e. performance 20 times higher than what currently exists in the field of drones.

Also advantageously, said drone 1 is connected to a geolocation system, after checking the ground, it permits to program the frequency, the quantity, and the place of release of the capsules 11 depending on the flight plan and the doses necessary for the treatment.

Preferably, the capsules 11 contain biological agents for pest control at different stages of their development, which permit a curative or preventive treatment of the pests.

Thus, through the configuration of the system for releasing and dispensing 3 the capsules 11, and under the effect of the instructions of the management means, the drone 1 of the invention permits to treat a field by spraying capsules 11 containing biological agents for pest control.

By being free of the turbulences, the release of capsules 11 on the soil is accurate and can occur depending on the environment according to a geolocation system predefined by the flight plan.

Advantageously, the drone 1 of the invention has a 1-hour flight autonomy and can reach a flight speed permitting to treat 100 ha/hour by spraying in an accurate and controlled manner capsules containing biological agents for pest control.

The piloting software of drone permits to pilot four drones simultaneously by the same operator from the same piloting console or computer in radio contact with the drone. This device permits to reach a rate of 400 ha/hour on territories composed of large plains or large plateaus such as those that can be found in South America, USA, Africa, Australia . . . .

The use of the drone 1 therefore permits to save time and money and to improve in accuracy compared to the existing devices.

1. Drone for spraying capsules containing biological agents for pest control, the spraying drone comprising:
propulsion means ensuring the displacement of the drone in a horizontal direction parallel to the ground, and
a system for dispensing and releasing the capsules provided with a vertical ejector, so that the ejection in flight to the ground of the capsules is in a direction perpendicular to the horizontal direction of displacement of the drone,
wherein, taking into consideration the direction of displacement of the drone, the vertical ejector is positioned in front of the propulsion means, and
wherein the system for dispensing and releasing the capsules comprises a reservoir with capsules connected to an element for guiding the capsules to a capsule counting and dosing system the capsule counting and dosing system comprising a plate for selecting and isolating the capsules,
wherein the plate for selecting and isolating the capsules is provided with calibrated orifices configured to let a single capsule pass through toward the vertical discharge ejector, and the plate is mounted in rotation relative to the vertical ejector through a pulse generating motor.

2. Drone for spraying capsules according to claim 1, wherein the drone consists of a fixed flying wing.

3. Drone for spraying capsules according to claim 1, wherein the drone comprises means for managing, through software, a flight plan, a speed of displacement of the drone, a frequency of release of the capsules by the dispensing and releasing system relative to a surface to be treated, a number of capsules available, and an area to be treated.

4. Drone for spraying capsules according to claim 1, wherein the counting and dosing system comprises an infrared system for detecting the capsules, so as to be capable of counting the number of dispensed and released capsules.

5. Drone for spraying capsules according to claim 1, wherein the pulse generating motor comprises a valve connected to a permanently rotating motor through a connecting-rod system.

6. Drone for spraying capsules according to claim 1, wherein the pulse generating motor comprises a stepping motor.

7. Drone for spraying capsules according to claim 2, wherein the drone comprises means for managing, through software, a flight plan, a speed of displacement of the drone, a frequency of release of the capsules by the dispensing and releasing system relative to a surface to be treated, a number of capsules available, and an area to be treated.

8. Drone for spraying capsules according to claim 2, wherein the counting and dosing system comprises an infrared system for detecting the capsules, so as to be capable of counting the number of dispensed and released capsules.

9. Drone for spraying capsules according to claim 3, wherein the counting and dosing system comprises an infrared system for detecting the capsules, so as to be capable of counting the number of dispensed and released capsules.

10. Drone for spraying capsules according to claim 7, wherein the counting and dosing system comprises an infrared system for detecting the capsules, so as to be capable of counting the number of dispensed and released capsules.

11. Drone for spraying capsules according to claim 2, wherein the pulse generating motor comprises a valve connected to a permanently rotating motor through a connecting-rod system.

12. Drone for spraying capsules according to claim 3, wherein the pulse generating motor comprises a valve connected to a permanently rotating motor through a connecting-rod system.

13. Drone for spraying capsules according to claim 4, wherein the pulse generating motor comprises a valve connected to a permanently rotating motor through a connecting-rod system.

14. Drone for spraying capsules according to claim 7, wherein the pulse generating motor comprises a valve connected to a permanently rotating motor through a connecting-rod system.

15. Drone for spraying capsules according to claim 2, wherein the pulse generating motor comprises a stepping motor.

16. Drone for spraying capsules according to claim 3, wherein the pulse generating motor comprises a stepping motor.

17. Drone for spraying capsules according to claim 4, wherein the pulse generating motor comprises a stepping motor.

18. Drone for spraying capsules according to claim 5, wherein the pulse generating motor comprises a stepping motor.

19. Drone for spraying capsules according to claim 7, wherein the pulse generating motor comprises a stepping motor.

20. Drone for spraying capsules according to claim 8, wherein the pulse generating motor comprises a stepping motor.
